(19) United States
(12) Patent Application Publication
(10) Pub. No.: US 2026/0332442 A1
(43) Pub. Date: Oct. 22, 2026

(54) DATA STORAGE DEVICE, MOBILE OBJECT, AND STORAGE MEDIUM STORING DATA STORAGE PROGRAM

(71) Applicant: DENSO CORPORATION, Kariya-city (JP)

(72) Inventors: Hayato SAKAMOTO, Kariya-city (JP); Xin XU, Kariya-city (JP)

(21) Appl. No.: 19/700,549

(22) Filed: Jun. 8, 2026

Related U.S. Application Data
(63) Continuation of application No. PCT/JP2024/035046, filed on Oct. 1, 2024.

(30) Foreign Application Priority Data
Dec. 11, 2023 (JP) 2023-208385

(51) Int. Cl. H04L 9/00

(52) U.S. Cl. CPC H04L 9/50

(57) ABSTRACT

A data storage device stores protection target data acquired in the mobile object using a blockchain, causes a secure storage of a secure world to store a first hash value of the protection target data, requests generation of a block based on the protection target data, which is connected to the blockchain, and calculates a second hash value of the protection target data in response to a request, and generates the block when the first hash value and the second hash value match.

### CROSS REFERENCE TO RELATED APPLICATIONS

The present application is a continuation application of International Patent Application No. PCT/JP2024/035046 filed on Oct. 1, 2024, which designated the U.S. and claims the benefit of priority from Japanese Patent Application No. 2023-208385 filed on Dec. 11, 2023. The entire disclosures of all of the above applications are incorporated herein by reference.

### TECHNICAL FIELD

The present disclosure relates to a data storage device, a mobile object, and a data storage program.

### BACKGROUND

In recent years, the importance of data acquired by a mobile object such as a vehicle has been increasing. Therefore, there is a demand for a device capable of storing data acquired by a mobile object such as a vehicle while ensuring credibility.

A data storage device in which an in-vehicle ECU stores acquired data in a vehicle using a blockchain has been known as a comparative example. In the data storage device described in the comparative example, a block generation unit generates one block based on a preset specified number or specified capacity of log data.

### SUMMARY

According to an aspect of the present disclosure, a data storage device may store protection target data acquired in the mobile object using a blockchain, and may include: at least one of (i) a circuit and (ii) a processor with a memory storing computer program code executable by the processor, the at least one of the circuit and the processor configured to cause the data storage device to serve as: a storage processing unit configured to cause a secure storage of a secure world to store a first hash value of the protection target data; a block generation request unit configured to request generation of a block based on the protection target data, which is connected to the blockchain; and a block generation unit configured to calculate a second hash value of the protection target data in response to a request, and generate the block when the first hash value and the second hash value match.

### BRIEF DESCRIPTION OF DRAWINGS

FIG. 1 is a block diagram showing an electrical configuration of an in-vehicle ECU according to an embodiment together with a related in-vehicle configuration.

FIG. 2 is a flowchart showing details of a logger process executed by a logger.

FIG. 3 is a flowchart showing a flow of a process for securely generating a block based on data desired to be protected at a timing desired to be protected, which is executed by the in-vehicle ECU according to the embodiment.

### DETAILED DESCRIPTION

As described above, in the data storage device described in the comparative example, the timing for generating a block is when the log data reaches a preset specified number or specified capacity, so it is not possible to generate a block at a timing when it is desired to generate a block immediately, such as at the time of an accident.

In view of the above background, it is an object of the present disclosure to provide a data storage device, a mobile object, and a data storage program capable of securely generating a block based on data desired to be protected at a timing desired to be protected.

The present disclosure adopts the following technical means to solve the above difficulty. The reference numerals in parentheses described in the claims and this section are examples showing correspondence with specific means described in the embodiments described later as one aspect, and do not limit the technical scope of the present disclosure.

According to one aspect of the present disclosure, a data storage device is used in a mobile object, stores protection target data acquired in the mobile object using a blockchain, and includes: a storage processing unit configured to cause a secure storage of a secure world, to which access from a normal world is restricted, to store a first hash value of the protection target data; a block generation request unit configured to request generation of a block based on the protection target data, which is connected to the blockchain; and a block generation unit configured to calculate a second hash value of the protection target data in response to a request from the block generation request unit, and generate the block when the first hash value and the second hash value match.

According to this configuration, when the first hash value of the protection target data stored in the secure storage matches the second hash value of the protection target data calculated in response to the request from the block generation request unit, a block based on the protection target data is generated. Thus, it is possible to securely generate a block in response to a block generation request from the block generation request unit.

A mobile object of one aspect of the present disclosure comprises the above data storage device.

According to an aspect of the present disclosure, a data storage program used in a mobile object and storing protection target data acquired in the mobile object using a blockchain, the data storage program causing a computer to function as: a storage processing unit configured to cause a secure storage of a secure world, to which access from a normal world is restricted, to store a first hash value of the protection target data; a block generation request unit configured to request generation of a block based on the protection target data, which is connected to the blockchain; and a block generation unit configured to calculate a second hash value of the protection target data in response to a request from the block generation request unit, and generate the block when the first hash value and the second hash value match.

Hereinafter, an embodiment of the present disclosure will be described with reference to the drawings. The embodiment described below shows an example when implementing the present disclosure, and do not limit the present disclosure to the specific configurations described below. In implementing the present disclosure, specific configurations according to the embodiments may be adopted as appropriate.

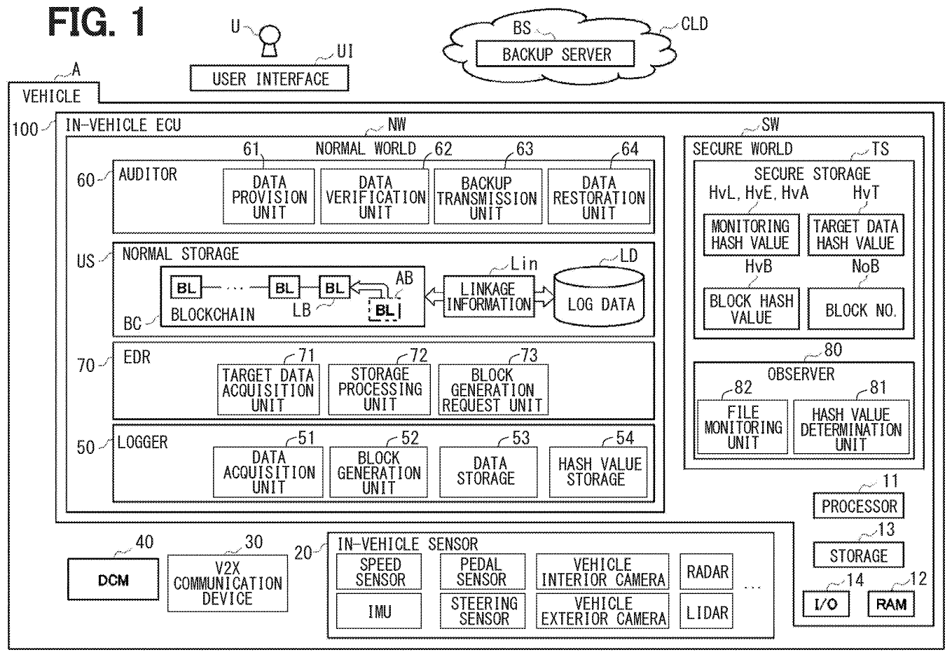

FIG. 1 is a block diagram showing an electrical configuration of an in-vehicle ECU (Electronic Control Unit) 100 according to an embodiment of the present disclosure together with a related in-vehicle configuration. The functions of the data storage device shown in FIG. 1 are implemented in the in-vehicle ECU 100. The in-vehicle ECU 100 is one of multiple electronic control units mounted on a vehicle A as an example of a mobile object. The in-vehicle ECU 100 may be, for example, a body system integrated ECU, or an autonomous driving ECU for autonomous driving or advanced driving support. Furthermore, the in-vehicle ECU 100 may be a dedicated ECU for storing acquired data. The in-vehicle ECU 100 is electrically connected directly or indirectly to a DCM (Data Communication Module) 40, a V2X (Vehicle to Everything) communication device 30, and an in-vehicle sensor 20 including multiple types of sensors, etc.

The DCM 40 is a communication module mounted on the vehicle A. The DCM 40 transmits and receives radio waves to and from a base station around the vehicle A by wireless communication in accordance with communication standards such as LTE (Long Term Evolution) and 5G. The DCM 40 enables cooperation between a cloud CLD and an in-vehicle equipment (Cloud to Car). By mounting the DCM 40, the vehicle A becomes a connected car capable of connecting to the Internet. The DCM 40 transmits a backup of data stored in the in-vehicle ECU 100 to a backup server BS installed on the cloud CLD. In addition, the DCM 40 receives backup data stored in the backup server BS.

The V2X communication device 30 is an in-vehicle communication device that implements vehicle-to-vehicle communication, road-to-vehicle communication, pedestrian-to-vehicle communication, and the like. The V2X communication device 30 is capable of bidirectional communication with these communication configurations when an in-vehicle device mounted on another vehicle, a roadside device installed on a road, a portable terminal carried by a pedestrian, or the like exists in a communication range. The V2X communication device 30 is capable of transmitting communication data acquired through communication to the in-vehicle ECU 100, for example, through a communication bus of an in-vehicle communication network.

The in-vehicle sensor 20 includes multiple types of sensors mounted on the vehicle A. The in-vehicle sensor 20 includes a speed sensor and an inertial sensor (Inertial Measurement Unit, IMU) that detect a traveling state of the vehicle A. The in-vehicle sensor 20 includes an in-vehicle camera, a pedal sensor, and a steer sensor that detect a state of a driver and a driving operation. The in-vehicle sensor 20 includes an external camera, a millimeter wave radar, and a LiDAR used for driving support or autonomous driving. The in-vehicle sensor 20 is capable of transmitting detection data to the in-vehicle ECU 100, for example, through a communication bus of an in-vehicle communication network.

The in-vehicle ECU 100 is an in-vehicle computer having a function as a data storage device that acquires data generated in the vehicle A and accumulates the acquired data as log data LD in a state where falsification is difficult. The in-vehicle ECU 100 is mainly configured by a control circuit including a processor 11, a RAM (Random Access Memory) 12, a storage 13, an input/output interface 14, and the like.

The processor 11 is hardware for arithmetic processing coupled to the RAM 12, and is capable of executing various programs by access processing to the RAM 12. The storage 13 is a configuration including a non-volatile storage medium, and stores various programs executed by the processor 11. The storage 13 stores at least a data storage program related to accumulation, provision, and monitoring of the log data LD generated in the vehicle A.

The in-vehicle ECU 100 defines at least two different processing regions, a normal world NW and a secure world SW, in the system. The normal world NW and the secure world SW may be physically separated on hardware, or may be virtually separated by cooperation of hardware and software. As an example, the in-vehicle ECU 100 uses a function such as a context switch to separate resources necessary for execution of an application into the normal world NW and the secure world SW.

The normal world NW is a normal region for executing an operating system and an application. In the normal world NW, a normal storage US is provided as a storage region (Untrusted Storage) for data storage.

The secure world SW is a region isolated from the normal world NW. In the secure world SW, a secure operating system and an application for processing requiring security are executed. Access from the normal world NW to the secure world SW is restricted by the function of the processor 11. Therefore, the existence of the secure world SW cannot be recognized from the normal world NW. The safety of processing executed in the secure world SW and information stored in the secure world SW is ensured. In the secure world SW, a secure storage TS is provided as a storage region (Trusted Storage) for data storage. The capacity of the secure storage TS may be smaller than the capacity of the normal storage US.

The in-vehicle ECU 100 of the present embodiment stores acquired data using a blockchain BC. Further, the in-vehicle ECU 100 of the present embodiment executes logger processing for storing the log data LD, EDR processing for securely storing data TD desired to be protected (hereinafter, sometimes referred to as “protection target data”) in association with the blockchain BC at a timing desired to be protected, data provision processing for providing the log data LD accumulated by the logger processing and/or the EDR processing to the outside, system monitoring processing for monitoring a state of the system, and the like. As functional units for executing each of the above processes, the in-vehicle ECU 100 includes a logger 50, an EDR (Event Data Recorder) 70, and an auditor 60 that operate in the normal world NW, and an observer 80 that operates in the secure world SW.

The logger 50 is a functional unit that stores various data generated in the vehicle A in association with the blockchain BC by executing the logger processing. The logger 50 has functional units such as a data acquisition unit 51, a block generation unit 52, a data storage 53, and a hash value storage 54.

The data acquisition unit 51 is electrically connected to, for example, a communication bus of an in-vehicle communication network. The data acquisition unit 51 is capable of acquiring various data generated in the vehicle A, such as communication data and detection data, through the communication bus. The data acquisition unit 51 extracts preset data from data sequentially output to the communication bus by the in-vehicle sensor 20 and the V2X communication device 30, selectively acquires the data as acquired data to be stored, and stores the data as log data LD in the normal storage US.

The block generation unit 52 has a function of calculating a hash value using a hash function such as SHA-256. The block generation unit 52 converts the log data LD into a hash chain data structure using the hash function. The block generation unit 52 creates one block based on a preset specified number or specified capacity of log data LD. The block generation unit 52 generates the blockchain BC in which multiple blocks are linearly connected by including a hash value obtained by inputting data of one block to the hash function in the next block.

The block generation unit 52 calculates a hash value stored as body data in each block based on the specified number or specified capacity of log data LD acquired by the data acquisition unit 51. The block generation unit 52 may individually calculate a hash value for each of multiple pieces of log data LD, or may calculate a Merkle root of multiple pieces of log data LD. In the present embodiment, a hash value is stored as body data in each block, but the log data LD itself may be stored in each block instead of the hash value of the log data LD.

The data storage 53 stores the log data LD acquired by the data acquisition unit 51 in a file path specified in the normal storage US. The data storage 53 stores data of the blockchain BC generated by the block generation unit 52 in the normal storage US. The data storage 53 stores association information Lin associating a specific block with the file path of the log data LD included in the specific block in the normal storage US.

The hash value storage 54 is capable of updating a block hash value HvB and a block number NoB stored in the secure storage TS by execution of a predetermined instruction (e.g., a secure monitor call, etc.) enabling access to the secure world SW. The block hash value HvB is a hash value based on the current final block LB of the blockchain BC. The block hash value HvB is a 256-bit value (character string) obtained as an output by arithmetic processing of inputting all data of the final block LB to the hash function.

The block number NoB is a unique value assigned to the final block LB, and is a value indicating what number the current final block LB is in the blockchain BC when the initial block is “0”. The block number NoB is also a value indicating the number of blocks currently connected to the blockchain BC. The hash value storage 54 updates the block hash value HvB and the block number NoB of the secure storage TS every time the block generation unit 52 generates a new block AB and calculates a hash value thereof.

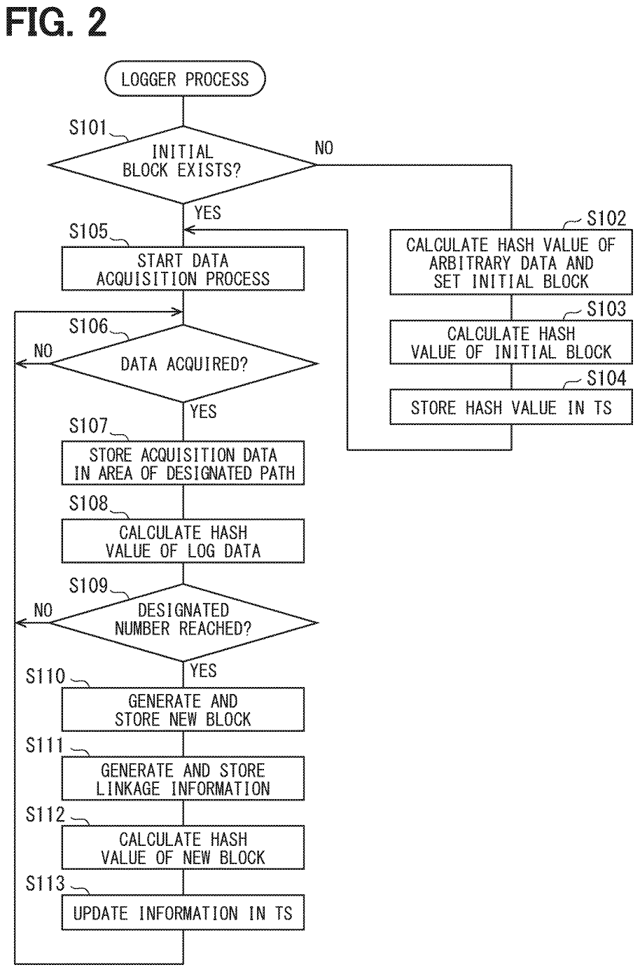

Details of the logger processing performed by the logger 50 described above will be described below based on the flowchart shown in FIG. 2 with reference to FIG. 1. The logger process starts based on the start of power supply to the in-vehicle ECU 100, and is continuously executed until the end of power supply.

In step S101, the block generation unit 52 determines whether an initial block of the blockchain BC has already been generated in the normal storage US. If it is determined in step S101 that there is an initial block in the normal storage US, the flow proceeds to step S105. On the other hand, when it is determined in step S101 that there is no initial block in the normal storage US, the flow proceeds to step S102 for executing the initial process.

In step S102, the block generation unit 52 calculates a hash value based on arbitrary data, and generates an initial block storing the hash value. The data storage 53 stores the generated initial block in the normal storage US.

In step S103, the block generation unit 52 calculates a hash value of the initial block set in step S102.

In step S104, the hash value storage 54 stores the hash value calculated in step S103 in the secure storage TS as an initial value of the block hash value HvB. In addition, in step S104, the hash value storage 54 records “0” as an initial value in an address of the secure storage TS storing the block number NoB.

In step S105, the data acquisition unit 51 starts processing for acquiring data to be accumulated as the log data LD.

In step S106, the data acquisition unit 51 determines whether acquired data to be stored has been acquired. When data to be stored is not acquired, the occurrence of the corresponding data is awaited by repeating the determination of step S106. Then, at the timing when the data acquisition unit 51 acquires data to be stored from the communication bus, the flow proceeds from step S106 to step S107.

In step S107, the data storage 53 stores the acquired data as log data LD in a specific storage region of the normal storage US in accordance with the instruction of the file path.

In step S108, the block generation unit 52 calculates a hash value of the log data LD stored in step S107. In step S106 and step S108, the acquisition of the log data LD and the calculation of the hash value are sequentially executed, so that the processing load is distributed in time.

In step S109, the block generation unit 52 determines whether the log data LD stored in the new block AB has reached the specified number or the specified capacity. When the block generation unit 52 determines in step S109 that the log data LD has not reached the specified number or the specified capacity, the flow returns to step S106, and the data acquisition unit 51 continues collection of the log data LD. On the other hand, when the block generation unit 52 determines in step S109 that the log data LD has reached the specified number or the specified capacity, the flow proceeds to step S110. In step S109, the flow may proceed to step S110 based on the fact that an elapsed time from the previous generation of the new block AB is counted and a predetermined elapsed time has passed (timeout).

In step S110, the block generation unit 52 sets a hash value based on the current final block LB and the hash value of the log data LD calculated in step S108 as a set, and generates a new block AB including at least these hash values. The new block AB is stored in the normal storage US by the data storage 53, and connected to the blockchain BC as a new final block LB.

In step S111, the data storage 53 generates association information Lin and stores the association information Lin in the normal storage US. The association information Lin is information associating the new block AB generated in step S110 with a file path defining a storage destination of the log data LD whose hash value is included in the new block AB.

In step S112, the block generation unit 52 calculates a hash value of the new block AB.

In step S113, the hash value storage 54 updates the block hash value HvB of the secure storage TS using the hash value calculated in step S112. In addition, in step S113, the hash value storage 54 increments the value of the block number NoB recorded in the secure storage TS to match the block number of the new block AB. By repeating the above step S106 to step S113, storage of the log data LD associated with the blockchain BC is implemented.

In this way, the logger 50 stores the log data LD in association with the blockchain BC. However, as described above, when it is determined that the log data LD has reached the specified number or the specified capacity, or when a predetermined elapsed time has passed since the previous generation of the new block AB, the block generation unit 52 of the logger 50 generates a new block AB based on the log data LD. As described above, in the storage of the log data LD associated with the blockchain BC by the logger 50, the timing for generating the new block AB is left to the block generation unit 52. Therefore, the logger 50 cannot generate a block based on the log data LD at a timing when it is desired to generate a block immediately, such as at the time of an accident.

Therefore, the in-vehicle ECU 100 of the present embodiment further includes the EDR 70 as a functional unit for blocking the log data LD at a timing when it is desired to generate a block immediately, such as at the time of an accident. The EDR 70 is a functional unit that stores the protection target data TD generated in the vehicle A in association with the blockchain BC at a timing desired to be protected by executing EDR processing in cooperation with the logger 50 and the observer 80 described later. The EDR 70 is, for example, a drive recorder, and can record data related to an accident when the accident occurs in the vehicle A. The EDR 70 can record data, for example, from a predetermined time before the time when an accident occurred in the vehicle A to a predetermined time after the time when the accident occurred in the vehicle A. Further, for example, it is not limited to the case where an accident occurs in the vehicle A, the EDR 70 may record vehicle information including vehicle speed before and after a collision or a state close to a collision of the vehicle A accompanying deployment of an airbag or the like as time-series data. The EDR 70 has at least functional units such as a target data acquisition unit 71, a storage processing unit 72, and a block generation request unit 73.

The target data acquisition unit 71 is electrically connected to, for example, a communication bus of an in-vehicle communication network. The target data acquisition unit 71 is capable of acquiring protection target data TD desired to be protected among various data generated in the vehicle A, such as communication data and detection data, through the communication bus. The target data acquisition unit 71 acquires the protection target data TD from data sequentially output to the communication bus by the in-vehicle sensor 20 and the V2X communication device 30, and stores the data as log data LD in the normal storage US. When a predetermined operation occurs in the vehicle A, for example, when an accident occurs in the vehicle A, when the vehicle A performs dangerous driving, when another vehicle performing dangerous driving such as meandering or cutting in exists around the vehicle A, or the like, the target data acquisition unit 71 acquires the protection target data TD. Thus, the acquired protection target data TD can be acquired at a desirable timing, which is a timing when a predetermined operation occurs in the vehicle A, and stored using a blockchain.

For example, when the speed of the vehicle A detected from the output of the speed sensor becomes equal to or higher than a predetermined level, the target data acquisition unit 71 determines that it is in an abnormal traveling state of speeding, and may acquire the protection target data TD from a predetermined time before the time when the speed of the vehicle A became equal to or higher than the predetermined speed to a predetermined time after the time when the speed of the vehicle A became equal to or higher than the predetermined speed.

Further, the target data acquisition unit 71 may detect the state of the driver or the driving operation from the output of an in-vehicle camera, a pedal sensor, or a steer sensor, etc., determine that the state of the driver or the driving operation is abnormal in a predetermined case, and acquire the protection target data TD.

Further, the target data acquisition unit 71 may determine that the vehicle A is in an abnormal traveling state of runaway driving or spinning when the vibration level of the vehicle A detected from the output of the inertial sensor becomes equal to or higher than a predetermined vibration level or when the direction of the vehicle A detected from the output of the inertial sensor changes suddenly, and may acquire the protection target data TD.

Further, the target data acquisition unit 71 may detect another vehicle performing dangerous driving around the vehicle A from the output of an external camera, a radar, or a LiDAR, and acquire the protection target data TD.

The storage processing unit 72 stores the protection target data TD acquired by the protection target data acquisition unit 71 as log data LD in a file path specified in the normal storage US. The storage processing unit 72 calculates a target data hash value HvT (hereinafter, sometimes referred to as “first hash value”) of the protection target data TD acquired by the protection target data acquisition unit 71, transmits the target data hash value HvT to the secure world SW to which access from the normal world NW is restricted, and causes the secure storage TS of the secure world SW to store the target data hash value HvT. The storage processing unit 72 has a function of calculating a hash value using a hash function such as SHA-256. Preferably, at the timing when the protection target data TD is generated, the storage processing unit 72 stores the protection target data TD as log data LD in the normal storage US by specifying a file path, and causes the secure storage TS to store the target data hash value HvT of the protection target data TD. The target data hash value HvT is a hash value of the protection target data TD calculated at the timing when the protection target data TD is generated. Thus, by immediately storing the target data hash value HvT in the secure storage TS at the timing when the protection target data TD is generated, the possibility of an abnormality such as falsification or loss occurring in the protection target data TD is reduced, and it becomes easy to ensure the correctness of the target data hash value HvT stored in the secure storage TS.

The block generation request unit 73 requests the block generation unit 52 of the logger 50 to generate a block based on the protection target data TD acquired by the protection target data acquisition unit 71, which is connected to the end of the blockchain BC. The block generation unit 52 calculates a hash value of the protection target data TD (hereinafter, sometimes referred to as “second hash value”) stored as body data in a block newly generated based on the protection target data TD acquired by the protection target data acquisition unit 71 in response to a request from the block generation request unit 73. When a hash value determination unit 82 described later determines that the second hash value matches the target data hash value HvT (first hash value), the block generation unit 52 generates a block based on the protection target data TD. When the first hash value and the second hash value do not match, the block generation unit 52 does not generate a block and discards the protection target data TD. Thus, by generating a block only when the first hash value and the second hash value match, only correct protection target data TD in which an abnormality such as falsification or loss has not occurred can be securely blocked. Although the hash value of the protection target data TD is stored in each block, the protection target data TD itself may be stored in each block. Then, the block generation unit 52 calculates a hash value of the new block AB based on the newly generated protection target data TD.

The data storage 53 of the logger 50 stores association information Lin associating the block based on the protection target data TD generated by the block generation unit 52 with the file path of the protection target data TD included in the block in the normal storage US. The processing of storing the association information Lin in the normal storage US may be executed by the storage processing unit 72 of the EDR 70.

The hash value storage 54 of the logger 50 updates the block hash value HvB of the secure storage TS using the hash value of the new block AB based on the protection target data TD calculated by the block generation unit 52. In addition, the hash value storage 54 increments the value of the block number NoB recorded in the secure storage TS to match the block number of the new block AB.

The auditor 60 is a functional unit that executes data provision processing for providing the log data LD accumulated by the logger 50 and/or the EDR 70 to the user U, and data maintenance processing related to backup and restoration of the log data LD. The auditor 60 has a data provision unit 61 and a data verification unit 62 as functional units related to data provision processing.

The data provision unit 61 is capable of communicating with a user interface UI outside the in-vehicle ECU 100 by wire or wirelessly. The user interface UI is, for example, an HMI device mounted on the vehicle A, or a user terminal such as a smartphone, a tablet, or a personal computer. A user operation for referring to the log data LD is input to the user interface UI by the user U. The user interface UI outputs a reference request to the data provision unit 61 based on the user operation.

The data provision unit 61 accepts the reference request output by the user interface UI. In the reference request, a file path of log data LD that the user U desires to refer to is specified. The data provision unit 61 extracts the file path of the acquired reference request, and provides the file path to the data verification unit 62. When there is no difficulty in the verification result by the data verification unit 62, the data provision unit 61 returns the log data LD specified by the file path to the user interface UI that is the request source of the reference request.

Using the acceptance of the reference request by the data provision unit 61 as a trigger, the data verification unit 62 verifies an abnormality including the presence or absence of falsification of specific log data LD (request data) requested in the reference request using the block hash value HvB stored in the secure storage TS. The data verification unit 62 identifies a block number associated with the file path specified in the reference request based on the association information Lin. The data verification unit 62 executes recalculation of each hash value based on the log data LD for the identified block (hereinafter, sometimes referred to as “specific block SB”) and a block newer than the specific block SB, and verifies the consistency of the blockchain BC.

The data verification unit 62 determines an abnormality of the log data LD based on whether a hash value based on the recalculated final block LB matches the block hash value HvB stored in the secure storage TS. When the recalculated hash value of the final block LB matches the block hash value HvB, the data verification unit 62 determines that there is no abnormality such as falsification in the log data LD. On the other hand, when the recalculated hash value of the final block LB does not match the block hash value HvB, it is determined that there is a possibility of an abnormality such as falsification in the log data LD.

As shown in FIG. 1, the auditor 60 has a backup transmission unit 63 and a data restoration unit 64 as functional units related to a data maintenance process. The backup transmission unit 63 and the data restoration unit 64 cooperate with the DCM 40 to enable sharing of the log data LD with the backup server BS.

The backup transmission unit 63 detects generation of a new block AB by the block generation unit 52. When a new block AB is generated by the block generation unit 52, the backup transmission unit 63 transmits backup data of multiple pieces of log data LD whose hash values are stored in the new block AB to the external backup server BS. The backup server BS associates the backup data transmitted from the backup transmission unit 63 with the ID information of the in-vehicle ECU 100, and stores the backup data in a large-capacity storage medium such as a hard disk drive.

In a situation where communication by the DCM 40 is impossible, the backup transmission unit 63 suspends transmission of the log data LD to the backup server BS. In this case, at a timing when the DCM 40 returns to a communicable state, the backup transmission unit 63 resumes transmission of untransmitted backup data.

The data restoration unit 64 detects an abnormality determination by the data verification unit 62. When an abnormality such as falsification or loss occurs in the log data LD or the like and the abnormality of the log data LD is determined by the data verification unit 62, the data restoration unit 64 restores the log data LD using the backup data stored in the backup server BS. The data restoration unit 64 requests the backup server BS to transmit backup data for multiple pieces of log data LD in which hash values are incorporated in each block subsequent to the specific block SB subjected to verification by the data verification unit 62. The data restoration unit 64 sets the backup data received from the backup server BS as normal log data LD, and overwrites the log data LD specified by the file path with the corresponding backup data. The data restoration unit 64 may perform processing of acquiring all backup data from the backup server BS and updating all log data LD.

By operating in the secure world SW, the observer 80 is protected from falsification from the outside of the in-vehicle ECU 100 and from the normal world NW. The observer 80 is a functional unit that monitors the states of the logger 50, the EDR 70, and the auditor 60 of the normal world NW from the secure world SW. The observer 80 has at least functional units such as a hash value determination unit 81 and a file monitoring unit 82.

The hash value determination unit 81 operates in the secure world SW. The hash value determination unit 81 determines whether the first hash value (target data hash value HvT) matches the second hash value (hash value stored as body data in a block newly generated based on the protection target data TD acquired by the protection target data acquisition unit 71 in response to a request from the block generation request unit 73), and returns the determination result to the block generation unit 52 of the logger 50. Since the hash value determination unit 81 operates in the secure world SW, there is no risk that the execution file of the hash value determination unit 81 is falsified. Therefore, the correctness of the determination result of the determination performed by the hash value determination unit 81 is ensured, and a block can be securely generated. Further, by performing comparison determination of the hash value of the protection target data TD in the data storage device, secure blocking can be performed quickly and easily.

The file monitoring unit 82 operates in the secure world SW, and starts system monitoring processing at a predefined cycle, for example, for periodic monitoring. Since the file monitoring unit 82 operates in the secure world SW, there is no risk that the execution file of the file monitoring unit 82 is falsified. The file monitoring unit 82 determines the presence or absence of falsification of the execution file of the logger 50 required for execution of the logger processing, the execution file of the EDR 70 required for execution of the EDR processing, and the execution file of the auditor 60 required for execution of the data provision processing and the data maintenance processing. Thus, even when the logger 50, the EDR 70, and the auditor 60 are respectively operated in the normal world NW, their correct operations are ensured by the file monitoring unit 82 operating in the secure world SW. In addition, since each execution file that tends to have a large capacity can be stored in the normal storage US of the normal world NW, it is possible to accurately verify the presence or absence of falsification of each execution file while reducing the data capacity stored in the secure storage TS.

The file monitoring unit 82 acquires these execution files from the normal world NW. In other words, the execution file of the logger 50 is an execution file related to each of the data acquisition unit 51, the block generation unit 52, the data storage 53, and the hash value storage 54. Similarly, the execution file of the EDR 70 is, in other words, an execution file related to each of the target data acquisition unit 71, the storage processing unit 72, and the block generation request unit 73. The execution file of the auditor 60 is, in other words, an execution file related to each of the data provision unit 61, the data verification unit 62, the backup transmission unit 63, and the data restoration unit 64. The file monitoring unit 82 comprehensively acquires the entire execution files. The execution file includes, for example, a binary file. Furthermore, a compiler, a linker, a library, and the like may also be included in the execution file.

The file monitoring unit 82 inputs each execution file to a hash function in a predefined order, and calculates a hash value of the logger 50, a hash value of the EDR 70, and a hash value of the auditor 60, respectively.

In the secure storage TS, a hash value based on an initial execution file guaranteed to be free from falsification is stored as a monitoring hash value. Specifically, a logger hash value HvL based on a normal execution file of the logger 50, an EDR hash value HvE based on a normal execution file of the EDR 70, and an auditor hash value HvA based on a normal execution file of the auditor 60 are stored in the secure storage TS as monitoring hash values. The logger hash value HvL, the EDR hash value HvE, and the auditor hash value HvA are stored in the secure storage TS, thereby being protected from falsification by access from the outside and the normal world NW.

The file monitoring unit 82 determines whether the hash value based on the execution file of the logger 50 acquired in the current system monitoring processing matches the logger hash value HvL stored in the secure storage TS. Similarly, the file monitoring unit 82 determines whether the hash value based on the execution file of the EDR 70 acquired in the current system monitoring processing matches the EDR hash value HvE stored in the secure storage TS. Similarly, the file monitoring unit 82 determines whether the hash value based on the execution file of the auditor 60 acquired this time matches the auditor hash value HvA stored in the secure storage TS.

When the file monitoring unit 82 determines that each hash value calculated this time matches each of the monitoring hash values HvL, HvE, and HvA for each of the logger 50, the EDR 70, and the auditor 60, the file monitoring unit 82 makes a normal determination that each execution file is not falsified. On the other hand, when it is determined that at least one of the hash values calculated this time does not match each of the hash values HvL, HvE, and HvA, the file monitoring unit 82 makes an abnormal determination that there is a possibility of falsification in the execution file. In this case, error notification to the user U is performed, and a series of system monitoring processing is ended. Alternatively, the in-vehicle ECU 100 may be rebooted to shift to secure boot.

As described above, the file monitoring unit 82 operating in the secure world SW periodically monitors each execution file of the logger 50, the EDR 70, and the auditor 60, so that even when the logger 50, the EDR 70, and the auditor 60 are operated in the normal world NW, their correct operations are ensured by the file monitoring unit 82 operating in the secure world SW.

However, in periodic monitoring, for example, when the execution file of the EDR 70, which plays a major role when storing the protection target data TD in association with the blockchain BC at a timing desired to be protected, is falsified and becomes an illegal execution file, the illegal EDR 70 may request unintended data block generation.

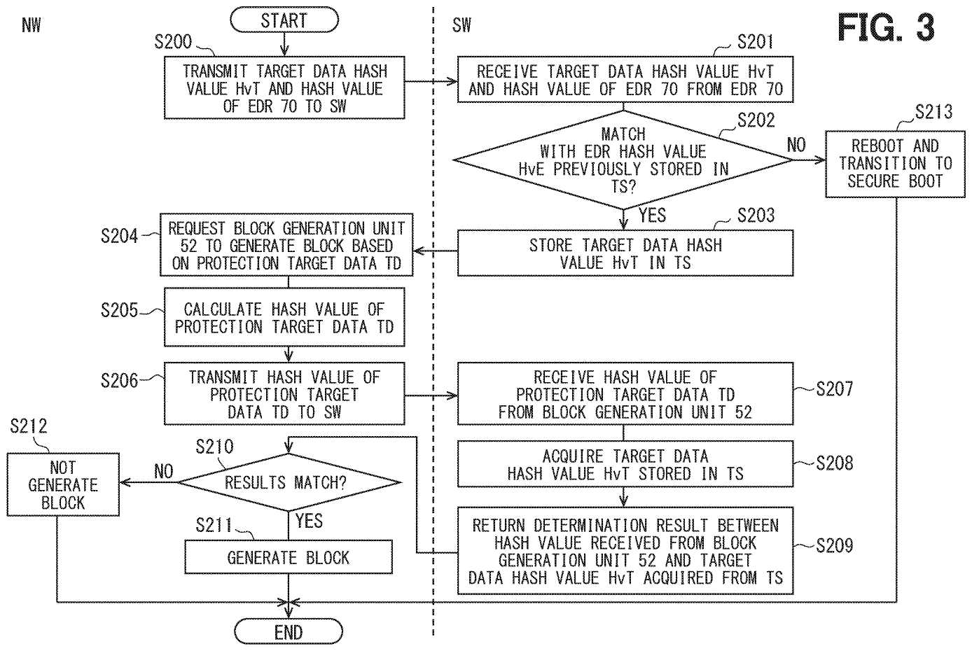

Therefore, in the in-vehicle ECU 100 of the present embodiment, processing for securely generating a block based on data desired to be protected at a timing desired to be protected is executed by cooperation of the EDR 70, the logger 50, and the observer 80 according to FIG. 3 described below.

FIG. 3 is a flowchart showing a flow of processing for securely generating a block based on data desired to be protected at a timing desired to be protected by cooperation of the EDR 70, the logger 50, and the observer 80. As described above, the EDR hash value HvE based on the normal execution file of the EDR 70 is stored in advance in the secure storage TS.

First, in step S200, the storage processing unit 72 calculates the target data hash value HvT of the protection target data TD acquired by the target data acquisition unit 71, and transmits the target data hash value HvT to the secure world SW in order to store the target data hash value HvT in the secure storage TS of the secure world SW. At this time, the storage processing unit 72 also transmits a hash value based on the execution file of the EDR 70 to the secure world SW together with the target data hash value HvT.

Next, in step S201, the file monitoring unit 82 receives the target data hash value HvT and the hash value based on the execution file of the EDR 70 from the EDR 70.

In the next step S202, the file monitoring unit 82 determines the presence or absence of falsification of the execution file of the EDR 70 received in step S201 according to whether the EDR hash value HvE (hereinafter, sometimes referred to as “first file hash value”) stored in advance in the secure storage TS and the hash value based on the execution file of the EDR 70 received in step S201 (hereinafter, sometimes referred to as “second file hash value”) match. In the case of an affirmative determination (YES), the flow proceeds to step S203, and in the case of a negative determination (NO), the flow proceeds to step S213.

In step S203, since the EDR hash value HvE stored in advance in the secure storage TS matches the hash value based on the execution file of the EDR 70 received in step S201, the instruction to store the target data hash value HvT in the secure storage TS by the storage processing unit 72 in step S200 is executed, and the target data hash value HvT is stored in the secure storage TS. Thus, in a normal case where there is no abnormality such as falsification or loss in the execution file of the EDR 70 (particularly, the execution file related to the block generation request unit 73), that is, when the EDR hash value HvE (first file hash value) and the second file hash value match, the target data hash value HvT is stored in the secure storage TS.

In step S204, using the storage of the target data hash value HvT in the secure storage TS as a trigger, the block generation request unit 73 requests the block generation unit 52 to generate a block based on the protection target data TD. At this time, the block generation request unit 73 may directly pass the protection target data TD to the block generation unit 52, or the block generation request unit 73 may pass the file path specified in the normal storage US of the protection target data TD to the block generation unit 52. Thus, first, in step S203, the target data hash value HvT is stored in the secure storage TS, and then a generation request for blocking the protection target data TD is made. By prioritizing and performing the storage of the target data hash value HvT in the secure storage TS first, the correctness of the target data hash value HvT stored in the secure storage TS is easily ensured.

In step S205, the block generation unit 52 calculates a hash value of the protection target data TD.

In step S206, the block generation unit 52 transmits the hash value of the protection target data TD calculated in step S205 to the secure world SW.

In step S207, the hash value determination unit 81 receives the hash value of the protection target data TD transmitted from the block generation unit 52 in step S206.

In step S208, the hash value determination unit 81 acquires the target data hash value HvT stored in the secure storage TS in step S203.

In step S209, the hash value determination unit 81 determines whether the hash value of the protection target data TD received from the block generation unit 52 in step S207 and the target data hash value HvT acquired in step S208 match, and returns the determination result to the block generation unit 52.

In step S210, the block generation unit 52 checks the determination result returned in step S209, and when the determination result indicates a match between the two (YES), the flow proceeds to step S211, and when the determination result indicates a mismatch between the two (NO), the flow proceeds to step S212.

In step S211, the block generation unit 52 generates a block based on the protection target data TD.

In step S212, the block generation unit 52 does not generate a block based on the protection target data TD, and discards the protection target data TD.

In step S213, which is entered when a negative determination is made in step S202, since the hash values of the execution files do not match, it is considered that there was an unintended data block generation request due to falsification of the execution file of the EDR 70 or the like, and the in-vehicle ECU 100 is rebooted, shifted to secure boot, and the target data hash value HvT is discarded. As a result, since the illegal execution file of the EDR 70 cannot store the hash value in the secure storage TS, the block generation unit 52 does not generate a block even when it receives an illegal blocking request.

As described above, the data storage device of the present embodiment is used in the mobile object A, and stores the protection target data TD acquired in the mobile object A using a blockchain. The data storage device of the present embodiment includes the storage processing unit 72 configured to cause the secure storage TS of the secure world SW, to which access from the normal world NW is restricted, to store the first hash value of the protection target data TD, the block generation request unit 73 configured to request generation of a block based on the protection target data TD, which is connected to the blockchain BC, and the block generation unit 52 configured to calculate the second hash value of the protection target data TD in response to a request from the block generation request unit 73, and generate the block when the first hash value and the second hash value match.

With this configuration, in the data storage device of the present embodiment, when the first hash value of the protection target data TD stored in the secure storage TS matches the second hash value of the protection target data TD calculated in response to the request from the block generation request unit 73, a block based on the protection target data TD is generated. Therefore, it is possible to securely generate a block in response to a block generation request from the block generation unit 52.

### Other Embodiments

The embodiments of the present disclosure have been described above, but the present disclosure should not be interpreted as being limited to the above embodiments, and can be applied to various embodiments and combinations without departing from the gist of the present disclosure.

In the above embodiment, the protection target data TD acquired by the EDR 70 and the data acquired by the logger 50 are stored using the common blockchain BC. However, in a first modification of the above embodiment, the blockchain used when storing the protection target data TD acquired by the EDR 70 and the blockchain used when storing the protection target data TD acquired by the logger 50 are separated. In this case, the EDR 70 may also be provided with functional units corresponding to the block generation unit 52, the data storage 53, and the hash value storage 54.

The auditor 60 of the above embodiment operates in the normal world NW. However, in a second modification of the above embodiment, the auditor 60 operates in the secure world SW. As described above, when there is a margin in the calculation resources of the secure world SW, the auditor 60 may be arranged in the secure world SW as in the second modification. In this case, the function of the observer 80 for monitoring the auditor 60 can be omitted.

In a third modification of the above embodiment, the function of transmitting backup data to the backup server BS is omitted. The in-vehicle ECU 100 of such a form can be mounted on a vehicle A that is not a connected car.

In a fourth modification of the above embodiment, the calculation timing of the hash value of the log data LD in the logger processing is different. Specifically, in the logger processing of the fourth modification, when it is determined that the log data LD has reached the specified number or the specified capacity, each hash value of all the log data LD to be incorporated into one block is calculated. As described above, a flow of calculating the hash of all the log data LD at once after they are prepared may be adopted.

In the above embodiment, the form in which the normal world NW and the secure world SW are defined for the in-vehicle ECU 100 has been described, but the present disclosure is not limited to this, and the secure world SW may not be defined in the in-vehicle ECU 100. In this form, the block hash value HvB, the block number NoB, the monitoring hash values HvL, HvE, HvA, the target data hash value HvT, and the like are stored in the normal storage US of the normal world NW, but these data may be stored in a storage similar to the secure storage TS such as a storage that cannot be directly accessed from the normal world NW or a storage to which access is restricted.

Data storable by the data storage device is not limited to text data. Depending on the capacity of the normal storage US, for example, audio data, image data, and video data may be stored. Furthermore, data stored in individual blocks of the blockchain BC may be changed as appropriate.

The hash function used in the in-vehicle ECU 100 of the above embodiment is a cryptographic hash function. The cryptographic hash function has characteristics that the same hash value is not output from different inputs and it is substantially impossible to guess the input from the output hash value. Instead of the above-mentioned SHA-256 which is one of SHA-2, each algorithm of SHA-1, SHA-2, and SHA-3 may be appropriately used according to the required output length (number of bits). Further, a unique value of data or a program and an irreversible value may be used instead of the hash value. Further, an irreversible unique value calculated from data may be used instead of the hash value. The unique value substituting for the hash value is, for example, Discrete Cosine Transform (DCT) or the like.

The vehicle A equipped with the in-vehicle ECU 100 may be an owner car privately owned by a specific owner and assumed to be used by the owner or the like. According to the application to the owner car, the log data LD indicating the driving history of the user accumulated in a state protected from fraud becomes highly valuable for a service provider who sets an insurance premium according to the driving situation, for example.

The vehicle equipped with the in-vehicle ECU 100 may be a vehicle for a rental car, a vehicle for a manned taxi, a vehicle for a ride share, a freight vehicle, a bus, or the like. Furthermore, the in-vehicle ECU 100 may be mounted on a driverless vehicle used for mobility service. With the spread of mobility services in the future, the importance of the log data LD accumulated in the in-vehicle ECU 100 is assumed to increase further.

Furthermore, the ECU having the function of the data storage device can be mounted on a mobile object different from a vehicle. For example, an ECU having the function of the data storage device can be mounted on heavy machinery operated at a work site, driving playground equipment arranged in an amusement facility or the like, a railway vehicle, a tram, an aircraft, and the like.

In the above embodiment, each function provided by the in-vehicle ECU 100 can be provided by software and hardware executing the software, only software, only hardware, or a complex combination thereof. When such a function is provided by an electronic circuit as hardware, each function can be provided by a digital circuit including a large number of logic circuits or an analog circuit.

Each processor of the above embodiment may be a configuration including at least one arithmetic core such as a CPU (Central Processing Unit) and a GPU (Graphics Processing Unit). Furthermore, the processor may be a configuration further including an FPGA (Field-Programmable Gate Array), an IP core having other dedicated functions, and the like.

The form of the storage medium adopted as the storage of the above embodiment and storing each program related to the data storage method of the present disclosure may be changed as appropriate. For example, the storage medium is not limited to a configuration provided on a circuit board, but may be provided in the form of a memory card or the like, inserted into a slot portion, and electrically connected to a bus of a computer. Furthermore, the storage medium may be an optical disk, a hard disk drive, or the like serving as a copy source of a program to a computer.

The control unit and the method thereof described in the present disclosure may be implemented by a dedicated computer configuring a processor programmed to execute one or more functions embodied by a computer program. Alternatively, the device and the method thereof described in the present disclosure may be implemented by a dedicated hardware logic circuit. Alternatively, the device and the method thereof described in the present disclosure may be implemented by one or more dedicated computers configured by a combination of a processor executing a computer program and one or more hardware logic circuits. Further, the computer program may be stored in a computer-readable non-transitory tangible recording medium as instructions executed by a computer.

Further, the flow of processing described in the above embodiment is also an example, and unnecessary steps may be deleted, new steps may be added, or the processing order may be changed without departing from the gist of the present disclosure.

Although the present disclosure has been described based on the embodiments, it is understood that the present disclosure is not limited to the embodiments and structures. The present disclosure also includes various modifications and variations within the equivalent range. In addition, various combinations and forms, and further other combinations and forms including only one element, more, or less, are also within the scope and spirit of the present disclosure.

What is claimed is:

1. A data storage device used in a mobile object and configured to store protection target data acquired in the mobile object using a blockchain, the data storage device comprising:
at least one of (i) a circuit and (ii) a processor with a memory storing computer program code executable by the processor, the at least one of the circuit and the processor configured to cause the data storage device to serve as:
a storage processing unit configured to cause a secure storage of a secure world, to which access from a normal world is restricted, to store a first hash value of the protection target data;
a block generation request unit configured to request generation of a block based on the protection target data, which is connected to the blockchain; and
a block generation unit configured to calculate a second hash value of the protection target data in response to a request, and generate the block when the first hash value and the second hash value match.

2. The data storage device according to claim 1, wherein
the storage processing unit is configured to cause the secure storage to store the first hash value of the protection target data at a timing when the protection target data is generated.

3. The data storage device according to claim 1, wherein
the block generation request unit is configured to request generation of the block in response to the storage processing unit causing the secure storage to store the first hash value.

4. The data storage device according to claim 1, wherein
the block generation unit is configured not to generate the block when the first hash value and the second hash value do not match.

5. The data storage device according to claim 1, wherein
the at least one of the circuit and the processor is further configured to cause the data storage device to serve as a hash value determination unit configured to determine whether the first hash value and the second hash value match, and return a determination result to the block generation unit.

6. The data storage device according to claim 5, wherein
the hash value determination unit is configured to operate in the secure world.

7. The data storage device according to claim 1, wherein
the at least one of the circuit and the processor is further configured to cause the data storage device to serve as a file monitoring unit configured to operate in the secure world and determine presence or absence of falsification of an execution file related to at least one of the block generation request unit, the storage processing unit, or the block generation unit.

8. The data storage device according to claim 7, wherein
in the secure storage, a hash value based on a normal execution file related to the block generation request unit is stored in advance as a first file hash value,
the file monitoring unit is configured to determine presence or absence of falsification of the execution file according to whether the first file hash value matches a second file hash value based on the execution file when the secure storage is caused to store the first hash value of the protection target data, and
the storage processing unit is configured to cause the secure storage to store the first hash value when the file monitoring unit determines that the first file hash value and the second file hash value match.

9. The data storage device according to claim 8, wherein
the storage processing unit is configured to reboot the data storage device and shift to secure boot when the file monitoring unit determines that the first file hash value and the second file hash value do not match.

10. The data storage device according to claim 1, wherein
the storage processing unit, the block generation request unit, and the block generation unit are configured to operate in the normal world.

11. The data storage device according to claim 1, wherein
the at least one of the circuit and the processor is further configured to cause the data storage device to serve as a target data acquisition unit configured to acquire the protection target data,
wherein
the target data acquisition unit is configured to acquire the protection target data when a predetermined operation occurs in the mobile object equipped with the data storage device.

12. A mobile object comprising
the data storage device according to claim 1.

13. A non-transitory computer-readable storage medium storing a data storage program used in a mobile object and storing protection target data acquired in the mobile object using a blockchain, the data storage program causing a computer to:
cause a secure storage of a secure world, to which access from a normal world is restricted, to store a first hash value of the protection target data;
request generation of a block based on the protection target data, which is connected to the blockchain;
calculate a second hash value of the protection target data in response to a request; and
generate the block when the first hash value and the second hash value match.
